(19) United States
(12) Patent Application Publication
(10) Pub. No.: US 2005/0035085 A1
(43) Pub. Date: Feb. 17, 2005

(54) APPARATUS AND METHOD FOR REDUCING METAL OXIDES ON SUPERALLOY ARTICLES

(76) Inventors: William Randolph Stowell, Rising Sun, IN (US); Daniel Peter Ivkovich JR., Fairfield, OH (US); Timothy Lance Manning, New Richmond, OH (US)

Correspondence Address: HASSE GUTTAG & NESBITT LLC, 7550 CENTRAL PARK BLVD., MASON, OH, 45040, US

(21) Appl. No.: 10/604,740

(22) Filed: Aug. 13, 2003

(51) Int. Cl. B08B 6/00; C23F 1/00

(52) U.S. Cl. 216/76; 134/1.1; 134/2; 134/21; 216/67

(57) ABSTRACT

A method of removing a metal oxide from an alloy surface of an article, such as a superalloy turbine blade for a gas turbine engine, by contacting the alloy surface within the vacuum environment of a vacuum chamber with a reductive plasma for a time sufficient to reduce the metal oxide. Typically, the reductive plasma stream is provided by a plasma torch that electrically charges a stream of hydrogen gas, most typically mixed with a much greater portion of an inert gas such as 95% argon, to generate an active plasma stream of H₃⁺ ions. Typically, a biasing circuit is made between the plasma torch and the alloy article to direct the plasma stream to the alloy surface.

### BACKGROUND OF INVENTION

This invention relates to the removal of metal oxides from alloy articles and, more particularly, to the cleaning of oxides from, followed by the repairing of, crevices in Ni-base and other superalloy articles.

During operation of such apparatus as a gas turbine engine that has alloy components, some of the components can experience a build up of corrosion on a surface of the alloy component, due to the harsh oxidizing environment of the gas turbine engine during operation. Some of the components can also experience damage such as might result from foreign objects impacting on the component, or from normal fatigue based on the cyclic life of the material from which the component is made. In the higher temperature operating portions of such apparatus, there are included airfoil components such as turbine blades and vanes which are expensive to replace and sometimes costly to repair.

A crack occurring in such engine airfoils can generate surface oxides in the crack because of the high temperature operation under oxidizing conditions. In the case of nickel-base superalloys which include the element Al and generally the element Ti, the creation of complex oxides including one or both of Al and Ti along with other elements of the superalloy from which such article is made, presents a difficult crack healing problem: the oxide must be removed in order to repair satisfactorily the crevice or crack. Such oxides are impractical to remove solely through exposure to a reducing atmosphere without exposing the superalloy article to a high temperature that is detrimental to its mechanical properties or to its structural integrity. Therefore, such repairs have sometimes been made by grinding out or cutting away and replacing the damaged portion of the component.

Batch thermo-chemical cleaning processes have been proposed for cleaning turbine components. Batch thermo-chemical cleaning processes attempt to remove oxides from crevices and hard-to-reach surfaces, while leaving the base alloy intact. The chemically stable oxides are generally resistant to conventional cleaning processes, such as, but not limited to, vacuum-reduction, hydrogen-reduction, or acid- and caustic-etching.

Several high-temperature, reactive-atmosphere batch cleaning processes have been proposed to affect cleaning of chemically stable oxides from turbine components. These processes generally rely on the high reactivity of fluoride ions. Processes that use fluoride ions for cleaning are collectively known as “fluoride ion cleaning” (FIC) processes.

Variants of the FIC process include a “mixed-gas process,” that employs a hydrofluoric (HF)/hydrogen (H₂) gas mixture; a “chromium fluoride decomposition process,” that employs solid chromium fluoride and hydrogen gas for cleaning; and a “fluorocarbon decomposition process,” that employs polytetrafluoroethylene (PTFE) and hydrogen gas for cleaning. FIC processes are conducted at elevated temperatures, where solid (s) metal oxide (MO) is converted to vapor-phase (v) metal fluoride (MF).

Differences between the various FIC processes include the fluoride ion source, reaction temperature, and reaction control mechanisms, and the composition of reaction byproducts. These differences, in turn, define a cleaning capability of each cleaning process. Both the fluorocarbon decomposition and chromium fluoride decomposition processes rely on finite sources of fluoride (PTFE or chromium fluoride, respectively). Prolonged process cycles can exhaust the fluoride source, causing the cleaning reaction to stop prematurely. The conventional mixed-gas FIC process uses an external, gaseous HF source and provides continuous control of fluoride activity through adjustment of the HF—H₂ ratio.

Furnaces with hydrogen atmospheres are used extensively to reduce the surface oxides of Fe, Ni, Co and Cr which can occur during oxidation exposure of common steels and simple Co- and Ni-base alloys. Therefore, such relatively simple alloys are routinely cleaned in hydrogen furnaces by a method sometimes referred to as “bright annealing”. However, a thermodynamic analysis shows that the reduction of oxides of Al and Ti requires temperatures or hydrogen purities currently unavailable in commercial hydrogen furnaces, vacuum furnaces or with commercial fluxes. For this reason, conventional repair of articles made from Ni-base superalloys has involved tedious and expensive mechanical removal of cracks, such as by grinding, for repair welding. Because oxides are present in narrow cracks or crevices, molten repair metal cannot wet walls of and flow into narrow crevices in the range of about 0.001-0.01 inch (25 250 microns). There has been reported in a paper, “Brazing in reducing fluoride-containing atmospheres” by E. Genieys, before The British Association for Brazing and Soldering, First International Brazing and Soldering Conference in London, England, 27-29 Nov. 1972, a method for reducing certain oxides through exposure to reducing fluoride atmospheres along with the concurrent brazing of members to be joined. The disclosure of that paper is incorporated herein by reference.

The treatment of the entire surface with hydrogen fluoride gas can be effective but requires treatment of the entire article which then must receive post-treatment, if previously coated. This can be costly. Localized treatment of the crack area is definitely preferred if accomplished effectively.

Thereafter, the cleaned crevice is repaired, such as by placing over the crevice a repair or healing alloy in powder form, placing the article in a vacuum and then heating the article to melt the repair alloy and to flow the repair alloy into and wet the walls of the crevice. In another form the repair step of the present invention includes applying over the opening of the crevice at the surface of the article a pressure barrier and then applying a combination of heat and isostatic pressure to the article in an amount and for a time sufficient to press together and diffusion bond the walls of the crevice.

### SUMMARY OF INVENTION

The present invention provides a method of removing a metal oxide from an alloy surface of an article, comprising the steps of: (1) placing the article within a vacuum chamber, (2) applying a vacuum within the environment of the chamber, (3) generating a reductive plasma within the vacuum environment of the chamber, and (4) exposing the alloy surface to the reductive plasma for a time sufficient to reduce the metal oxide.

The present invention provides a method of removing a metal oxide from an alloy surface of an article, comprising the steps of: (1) placing the article within a vacuum chamber, (2) applying a vacuum of about 20 torr or less within the environment of the chamber, (3) using a plasma torch to generate a concentration of active H₃⁺ ion within the vacuum environment of the chamber, the plasma torch comprising a discharge nozzle, an electrode in non-containing relation with the discharge nozzle, a source of a plasma-forming gas for passing through the discharge nozzle, and a power supply device for the formation of a non-transferred arc between the discharge nozzle and the electrode, and (4) positioning the discharge nozzle toward the article, to direct the concentration of active H₃⁺ ion toward the metal oxide on the alloy surface for a time sufficient to reduce the metal oxide.

The present invention further provides an apparatus of removing metal oxide from an alloy surface of an article, comprising: (1) a vacuum chamber, (2) an active H₃⁺ ion plasma generator, and (3) a means for directing a generated H₃⁺ ion plasma to the article.

### BRIEF DESCRIPTION OF DRAWINGS

FIG. 1 shows schematically an apparatus of the present invention that generates an active ion plasma using a plasma torch.

FIG. 2 shows schematically an apparatus of the present invention that generates an active ion plasma using a hollow cathode plasma generator.

FIG. 3 shows schematically a magnetic channeling device used to direct an active ion plasma generated by a plasma torch of the present invention.

### DETAILED DESCRIPTION

The present invention provides a method and an apparatus for effectively and efficiently removing metal oxide corrosion from the alloy surface of an article. The invention is particularly useful for removing metal oxide corrosion from superalloy components of gas turbine engines, and for removing metal oxides from within cracks that can develop on the alloy surface.

After an article has been thoroughly cleaned and deoxidized in accordance with the present invention, the cleaned article can be repaired, such as by ADH and brazing, and coated with any surface treatments including thermal barrier coatings.

An embodiment of the present invention utilizes a plasma generator, wherein a gas is passed through an electrical arc OLE_LINK1 contained between an anode and a cathode inside a nozzle to convert a stream of gaseous hydrogen gas into a reductive active ion plasma stream comprising H₃⁺ ionOLE_LINK1. Another embodiment of the invention utilizes a plasma generator wherein a hollow cathode effect is formed between opposed cathodic plates within the vacuum chamber to convert hydrogen gas into a reductive active ion comprising H₃⁺ ion. At the conditions of low absolute pressure, typically at pressures of about 20 torr and less, the invention generates a meta-stable reductive plasma. The reductive active plasma very efficiently and effectively reduces metal oxides on the alloy surfaces of article exposed to the active plasma.

A typical method of the present invention involves placing the article to be cleaned within a suitable chamber configured to withstand a low vacuum, within which the reductive active plasma is formed. Typically one or more similar or dissimilar articles can be treated according to the method of the invention. The method includes the step of reducing the pressure within the vacuum chamber, although articles can be transferred into the vacuum chamber at low vacuum conditions from a transfer chamber that serves as an airlock, as is well known in the art. The vacuum conditions can be applied or maintained by one or a combination of vacuum systems, such as pumps and ejectors, by means well known in the art. Similarly, the treated articles can be removed from the vacuum chamber via the transfer chamber.

The pressure conditions within the vacuum chamber are typically less than about 20 torr, and more typically less than 15 torr. Also typically, the pressure within the chamber is at least 0.1 torr, typically at least 1 torr, more typically at least 5 torr, and even more typically at least 10 torr. Most typically, the pressure within the chamber is about 10 torr to about 15 torr.

The method also includes the step of purging the chamber with a reducing gas prior to or during the applying of a vacuum. This minimizes the presence of any oxidative gas, such as oxygen, within the chamber during the process.

The invention also includes the steps of generating a reductive plasma within the vacuum environment, and exposing the alloy surface to the reductive plasma for a time sufficient to chemically reduce the metal oxide. The reductive plasma comprises a meta-stable plasma of active ions capable of chemically reducing the metal oxide. A typical reductive plasma ion species comprises H₃⁺. Other reductive active species can also be used, alone or in combination with H₃⁺, and include the active ions of carbon monoxide and the halogens, including chlorine, bromine, iodine and fluorine. The reductive active ion species can be formed separately, or jointly, such as by mixing hydrogen gas with the source of the other reductive ion species, such as CO, F₂, Cl₂, Br₂ and I₂ gas.

For the purposes of describing further the present invention, hydrogen will exemplify the plasma gas supply, and H₃⁺ will exemplify the reductive plasma ion species.

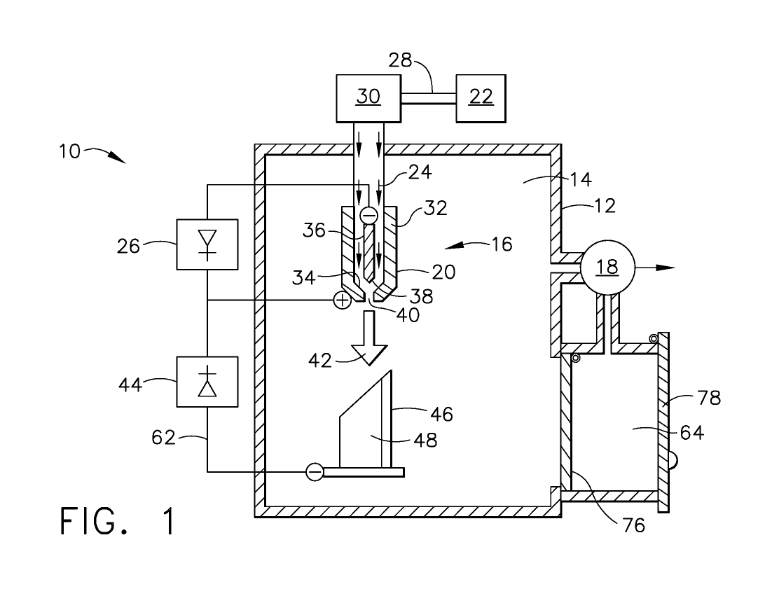

The reductive plasma ion species can be generated by various means. A first means of generating the ion species employs an active plasma generator, which generates a plasma stream from a gas stream comprising hydrogen gas. FIG. 1 shows an embodiment of an apparatus 10 comprising a vacuum chamber 12 and an active plasma generator 16. The active plasma generator comprises a plasma torch 20, a plasma gas supply means 22, and a main power source 26. The plasma arc torch 20 is positioned within the environment 14 of the chamber 12, and includes a water-cooled plasma nozzle 32 of a conductive material such as copper, and an electrode 36, typically of tungsten. The plasma torch 20 generates a non transferred type main arc (plasma arc) between the cathodic electrode 36 and the anodic plasma nozzle 32. The plasma torch 20 is typically configured to provide symmetrical orientation of the electrode 36 within the plasma nozzle 32. Typically the electrode and nozzle cross sectional profiles are circular and concentric. The electrode 36 can be a conventional electrode made of tungsten and containing 2% of ThO₂ or any tungsten electrode available commercially, typically having a diameter of about 10 millimeters or less.

The electrode 36 and the plasma nozzle 32 are required to be electrically isolated from and rigidly fixed to each other by means of an insulating member, not shown. Plasma nozzle 32 can be cooled by a cooling system, typically a water cooling system, not shown, to prevent over-heating by arc heat.

Plasma gas supply means 22 can include a high-pressure gas cylinder or a gas supply installation using centralized piping. The plasma gas supply means supplies plasma gas 24 by means of a pipe 28 to a gas regulator 30 which regulates a quantity (by volume rate in standard cubic feet per minute, SCFM, or in cubic meters per minute) of gas supplied to plasma nozzle 32. The plasma gas passes between a tip 38 of electrode 36 and the interior surface of the plasma nozzle 32, and exits the plasma torch through the plasma nozzle orifice 40.

The plasma torch produces a reductive plasma stream in the following manner. The vacuum chamber environment 14 is brought to a low pressure by evacuating and maintaining the low pressure by means of a vacuum system 18. Plasma gas 24 passes between the annular space between the tip 38 of the electrode 36 and the inner wall 34 of the plasma nozzle 32. Under the vacuum conditions and with an electrical potential applied between the plasma nozzle 32 and the electrode 36, a plasma arc forms across the pathway of the plasma gas 24, to generate a reductive, meta-stable plasma stream 42 comprising H₃⁺ ions. The electrical potential of the main power supply 26 applied is typically from about 20 volts to about 100 volts, more typically from about 30 volts to about 60 volts, at a current of from about 10 amps to about 1000 amps, more typically of from about 50 amps to about 150 amps.

The plasma product and any unreacted supply gas portion (for example, any inert gas portion) are ejected through the orifice 40 of the nozzle. The plasma stream 42 is discharged into vacuum chamber 12 as a concentration of H₃⁺ ions. The plasma stream can be directed at an alloy surface 48 of an article 46 to reduce a metal oxide on the alloy surface.

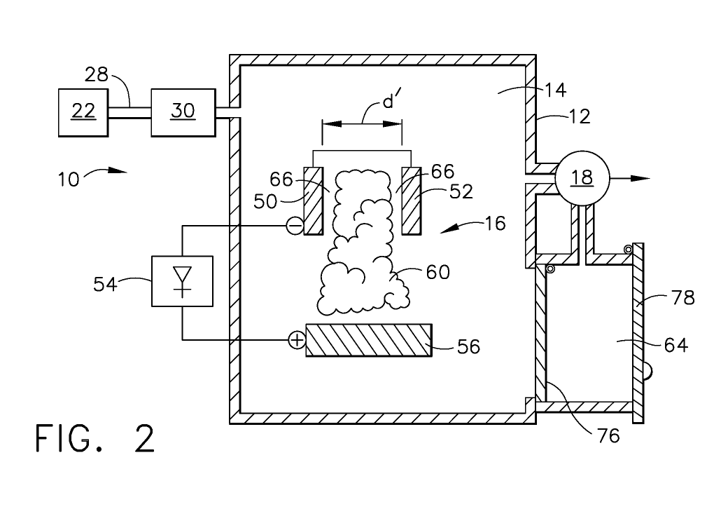

In an alternative embodiment of the invention, illustrated in FIG. 2, a second means of generating the ion species employs an passive plasma generator 16, which generates a concentration of plasma 60 from hydrogen gas utilizing a hollow cathode arrangement. The hollow cathode arrangement generates ions from a gas between two cathodes 50 and 52 under the effect of a positive D.C voltage potential applied by a power source 54 between an anode 56 and the cathodes. In a typical embodiment, the hollow cathodes 50, 52 are positioned parallel to and spaced a distance d from one another. The distance d can be adjusted and is a function of the type of ionized gas, the voltage differential between the anode 56 and cathodes 50, 52, and the pressure (vacuum) within the environment 14 of the vacuum chamber 12. The ionisable plasma gas supply circulates around the cathodes 50, 52 and the anode 56 under a low pressure. When the anode is charged to a potential V, a discharge occurs and an ionized plasma cloud 60 is generated that emits a brilliant glow that can be observed between the cathodes and extending up to the anode 56. In operation, the ions of this plasma are accelerated through the sheaths 66 (the space between the plasma and the cathode surface) towards the cathodes with a clearly defined energy which is substantially that arising out of the potential V. Typically the power source 54 provides a voltage potential of 10 volts to about 10,000 volts, and a current of about 10 milliamps to about 100 amps. Typically as well, a separate biasing circuit is made between the anode and the article acting as a cathode, to direct the H₃⁺ ion plasma toward the article. An article (not shown) with the alloy surface to be treated can typically be placed within the confines of the hollow cathodes so as to be exposed to an ionized plasma 60. Additional details of the hollow cathode arrangements discussed above can be found in the article by Gordon Francis entitled “The Glow Discharge at low Pressure” in Handbuch der Physik, Vol. 22, pages 91 et.seq, Springer Verlag, 1956, incorporated herein by reference.

In an alternative embodiment, an article, and more particularly the alloy surface of an article, can serve as one of or both of the cathodes, to generate the hollow cathode effect between one or more of the articles. As in the situation of a conventional hollow cathode arrangement, the article, acting as a cathode, is positioned substantially parallel to and spaced a distance d″ from a second cathode, or from a second article. The distance d″ can be adjusted and is a function of the type of ionized plasma gas, the voltage differential between the anode and cathodes, and the pressure.

In yet another alternative embodiment, a hollow cathode arrangement can be used to discharge a concentration of plasma ions. An example of an ion source generator using a hollow cathode arrangement for emitting a concentration of plasma ions is described in U.S. Pat. No. 4,087,721, incorporated herein by reference. FIG. 2 of U.S. Pat. No. 4,087,721 diagrammatically illustrates by way of example an exemplary embodiment of the reductive ion source according to the invention comprising, as before, a cathode, an anode, and an electrical source. A second cathode is provided that has a plurality of holes that allow some of the ions of the plasma to pass through and outside of the arrangement towards a target. These ions leave the plasma with the energy with which they normally collide with the solid cathodes of the hollow cathode arrangements described above. To prevent the charged ions from turning back towards the apertured cathode under the influence of the cathodes highly-positive space charge, a filament is provided in the path of the ion beam beyond the cathode. The filament is heated by an electrical source and brought to a slightly negative d.c. potential in relation to the potential of the cathodes by the main voltage source. The slow electrons emitted under these conditions by the filament neutralise the space charge in question and enable the ions to be propagated over a much greater distance to the point of use.

Plasma Directing and Concentration—An article having an alloy surface comprising a metal oxide is exposed to the concentration of the H₃⁺ ions for a time sufficient to reduce the metal oxide. Various means of concentrating or directing the generated reductive ion plasma toward the metal oxide can be used to more effectively and efficiently reduce the corrosive metal oxides from the alloy surfaces of the article. Such means can include: directing a stream of the reductive ion plasma toward the metal oxide; biasing the reductive ion plasma toward the alloy surface by employing a voltage potential between the alloy surface and the plasma generator; and channeling the plasma stream, such as with a magnetic field gradient. In addition, certain non-conductive and reduction-resistive coatings or barrier can be positioned onto or proximate any non-oxidized alloy surfaces to prevent dissipation of the reductive ion plasma across the entire surface of the article, and to avoid depleting alloy metal therefrom.

Directing a Plasma Stream—A first means of directing a concentration of reductive ion plasma at the alloy surface comprising the metal oxide is to direct the discharge of the plasma torch at the alloy surface. The plasma torch emits a stream of meta-stable reductive ion plasma from the nozzle as a stream of plasma. The plasma torch can be configured to be moveable within the vacuum chamber, to allow an operator to position the nozzle of the plasma torch. Alternatively, the plasma torch can be made stationary, and the article can be moved and positioned to confront the alloy surface with the nozzle.

Biasing a Plasma—A second means of directing a concentration of reductive ion plasma at the alloy surface comprising the metal oxide is to create a bias of movement of the plasma ions for the alloy surface. In a typical biasing means, an electrical potential is created between the anode of the plasma generator and the workpiece or alloy article. The electrical potential causes the positively-charged H₃⁺ ions of the plasma stream to be drawn from the plasma generator to the alloy article, a process which is commonly known as “reverse biasing”. A biasing means can be used with either the active plasma generator or with a passive plasma generator.

The reverse biasing means can be used in combination with other means for directing and concentrating the ion plasma to the alloy surface. In a typical embodiment employing a plasma torch 20 shown in FIG. 1, the plasma stream 42 emanating from the torch nozzle 32 is also biased toward the alloy surface 48 by a biasing circuit 66 which configures a biasing voltage potential between the plasma nozzle 32 and the alloy surface 48. Typically, the biasing potential is configured between about 30 and 60 V, and at least 1 amp, more typically between 50 and 100 amps and the distance between the plasma torch and the alloy surface is approximately 15 to 25 inches (38 to 64 cm). The biasing potential can be provided by the same main power source 26 used to generate the plasma stream, or more typically by an independent biasing power source 44. The adjustment of the current flow through the biasing circuit in turn controls the flow of H₃⁺ ions from the reductive ion plasma to the conductive alloy surface 48 of the article.

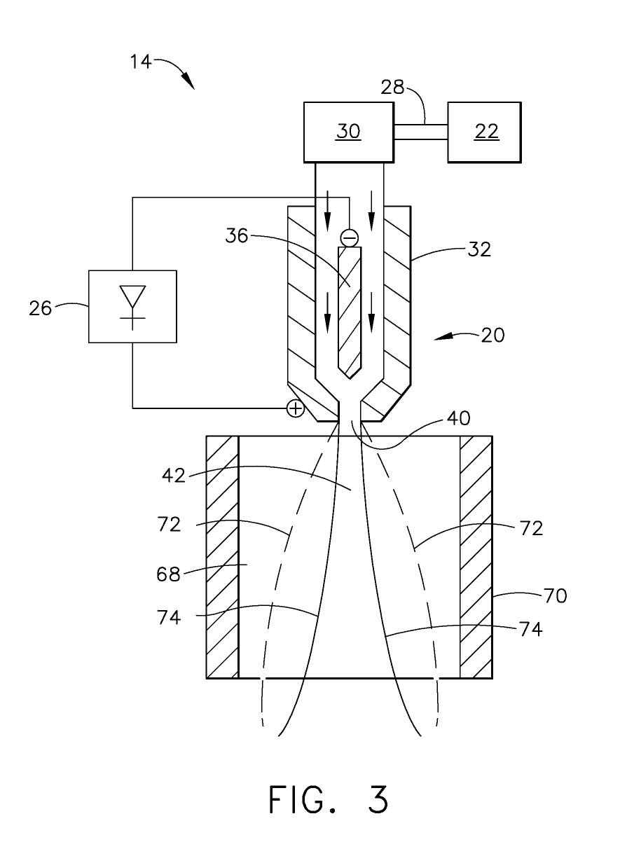

Magnetic channeling—Another embodiment of the invention further comprises a magnetically-generated channel 68 for directing and concentrating the generated ion plasma. As shown in FIG. 3, a plasma stream emitted from plasma torch 20 is passed through a magnetically-generated channel 68 generated by a permanent magnet 70 or an equivalent electromagnet, to shape the plasma stream, and to direct and concentrate the plasma stream, at the metal oxide on an alloy surface. The normal outline (without a channel 68) of the plasma stream 42 is shown as dashed lines 72. A hollow, cylindrical permanent magnetic member 70 can shape and concentrate the plasma stream emitted from the nozzle to a configuration illustrated by solid lines 74.

The polarity of the permanent magnetic member 70 is shown in FIG. 3 for purpose of illustration only. The polarities can be reversed while still achieving the same advantageous effects of plasma stream shaping. Additional permanent magnetic members can be used. The magnetic member 70 can assume other shapes and configurations. Alternatively, or in combination, an electromagnetic coil can be used to reshape a plasma stream. The electromagnetic coil is typically coupled to a DC power source to provide the necessary magnetic field.

Plasma Gas Supply—The typical plasma gas supply comprises a hydrogen gas. The hydrogen gas can further comprise other reducing gases and inert gases, and mixtures thereof. Reducing gases can comprise CO, a halogen gas, and mixtures thereof. Inert gases can comprise helium, argon, neon, xenon, and mixtures thereof. Because of the flammable and explosive potential of pure and high proportions of hydrogen gas, a more typical plasma gas supply comprises a major proportion of an inert gas and a minor proportion of hydrogen. A preferred plasma gas supply comprises from about 8% volume or less of hydrogen gas, and the remainder of an inert gas, typically argon. The inert gas also provides some mechanical abrading of the articles surface at which the plasmas stream is directed or targeted.

Apparatus—The invention includes an apparatus for use in removing metal oxides from alloy surfaces using a reductive plasma. Referring to FIG. 1, an apparatus 10 includes a vacuum chamber 12 and a vacuum system 18 for evacuating the environment 14 to pressures below about 20 torr, and down to at least about 0.1 torr. The chamber is provided with an opening through which an article to be treated can be introduced and removed. Typically, the opening is a sealed hatch 76 that opens into a small volume transfer chamber that serves as an airlock 64 between the vacuum chamber environment 14 and the outside environment. Workpieces can be placed into the airlock 64 via an outer door 78. The interior of the airlock can be evacuated to a vacuum condition by the vacuum system 18. A means (not shown) for transferring the workpiece between the airlock 64 and the vacuum chamber 12 is provided, and are well known in the field of plasma spraying.

The apparatus also comprises a generator 16 for forming an active H₃⁺ ion plasma, and a means for directing the generated H₃⁺ ion plasma to the article. Typically the plasma generator is positioned within the chamber, or nearby the chamber wherein the plasma discharge point is positioned within the chamber. The embodiment of the apparatus 10 shown in FIG. 1 uses a plasma torch 20 as the ion plasma generator 16.

Typical Alloys—Non-limiting examples of a nickel-base superalloy that can be susceptible to strain-age cracking can include: Rene 77, having a nominal composition, in weight percent, of 15.0 percent cobalt, 14.2 percent chromium, 4.3 percent aluminum, 3.4 percent titanium, 4.2 percent molybdenum, 0.5 percent iron, 0.2 percent silicon, 0.15 percent manganese, 0.07 percent carbon, 0.04 percent zirconium, 0.016 percent boron, balance nickel; Rene 80, having a nominal composition, in weight percent, of 9.5 percent cobalt, 14.0 percent chromium, 4.0 percent tungsten, 3.0 percent aluminum, 5.0 percent titanium, 4.0 percent molybdenum, 0.2 percent iron, 0.2 percent silicon, 0.2 percent manganese, 0.17 percent carbon, 0.03 percent zirconium, 0.015 percent boron, balance nickel; Rene 100, having a nominal composition, in weight percent, of 15.0 percent cobalt, 9.5 percent chromium, 5.5 percent aluminum, 4.2 percent titanium, 3.0 percent molybdenum, 1.0 percent iron, 1.0 percent vanadium, 0.5 percent silicon, 0.5 percent manganese, 0.18 percent carbon, 0.06 percent zirconium, 0.015 percent boron, balance nickel; and In-738, having a nominal composition, in weight percent, of 8.5 percent cobalt, 16.0 percent chromium, 3.4 percent aluminum, 3.4 percent titanium, 2.6 percent tungsten, 1.7 percent tantalum, 1.7 percent molybdenum, 0.11 percent carbon, 0.05 percent zirconium, 0.010 percent boron, balance nickel.

The present invention offers particular advantages to conventional methods used to remove oxide corrosion from alloy surfaces. Typically, the by-products of the reductive plasma method comprise hydrogen gas and any inert carrier gas. The plasma gas supply is typically commercially abundant gas mixtures that are both safe and effective. The entire reductive plasma operation will typically run up to several minutes to effectively remove the oxides.

### EXAMPLES

### Example 1

### Active H₃⁺ Ion Generator

A turbine blade is removed from a commercial gas turbine engine for routine maintenance. Within a conventional vacuum plasma chamber (such as from Sulzer Metco), the turbine blade is secured to an insulated stage. The blade is made of a Ni-based superalloy, and has a surface comprising metal oxide corrosion and a surface crevice comprising a metal oxide corrosion on the walls thereof. Any loose corrosion material has been removed before securing the blade into the chamber. A plasma torch is movably positioned within the chamber with its nozzle directed at a selected location of the turbine blade. The plasma torch is a conventional plasma torch, such as a model 3MB-II made by Sulzer Metco. The plasma torch has a watercooled copper nozzle (primary anode) and a tungsten electrode (primary cathode). The plasma supply gas contains 95% argon and 5% hydrogen, and is supplied from a compressed gas cylinder through a regulating valve and standard gas tubing to the plasma torch inlet. A main power source is provided to generate a potential between the anode-nozzle and the cathode-electrode of the plasma torch. A vacuum pump evacuates the chamber containing the plasma supply gas to a pressure of about 15 torr. A second power source is provided, with its positive terminal connected to the anode of the plasma torch, and the negative terminal connected with a terminal clamp to the turbine blade, and is provided with a voltage potential of about 40 volts and about 2 kilowatts.

With the plasma gas flowing through the torch, the main power source is energized (about 80 volts and about 20 kilowatts) and a brilliant plasma stream emanates from the nozzle of the plasma torch. The plasma torch nozzle is positioned to flood the metal oxide corrosion of the turbine blade with the plasma stream. After 10 minutes, the main power is cut. Upon removal, via an airlock, the turbine blade is inspected by Scanning Electron Microscopy and Energy Dispersive Analysis through X-ray spectroscopy (SEM/EDAX), revealing that the metal oxide corrosion has been completely removed from the alloy surface and from the walls within the crevice.

### Example 2

### Passive H₃⁺ Ion Generator

Within a conventional vacuum chamber with an electrical feed-thorough (such as from Varian) are arranged a pair of cathode angle pieces. The cathode angle pieces (iron) are electrically attached end to end and set apart at an angle of about 50 degrees to form a variable hollow cathode gap. The cathode angle pieces are contacted electrically with the negative terminal of a power source. The metallic inner wall of the chamber is connected to the positive terminal of the power source. Attached to the upright inner face of each angle piece is an alloy disc (chromium alloy, 25.4 mm diameter× about 5 mm thick). The alloy discs have a 1 mm wide slot cut through the thickness from the circumference to the center. Each alloy disc has been uniformly oxidized in an air furnace for one hour at 2000° F. to form a substantially uniform coating of metal oxides upon all surfaces, including those surfaces within the slot. The airspace within the chamber is flushed with a plasma gas mixture of about 95% argon and 5% hydrogen, at a reduced pressure of about 0.2 torr absolute and at room temperature.

The power source is turned on to create a voltage potential of about 1000 volts, creating a concentration of H₃⁺ plasma between the cathodes and between the alloy discs attached thereto. The system is operated for about 5 hours 23 minutes at steady conditions of about 1023 volts and about 30 milliamps, at a pressure of about 650 microns Hg (about 0.65 torr).

SEM analysis showed that the metal oxides were completely removed from some areas of the alloy surface, though other areas remained coated with a combination of untreated metal oxide and reduced metal. EDAX analysis of the partially-cleaned areas showed substantial amounts of chromium metal and chromium oxide.

### Example 3

The procedure according to Example 2 is repeated with the alloy discs preheated and maintained at a temperature of about 1800 2000° F. (982-1093° C.). Both visual and elemental analyses show that all the metal oxides on the alloy surface have been reduced to the base alloy metals.

1. A method of removing a metal oxide from an alloy surface of an article, comprising the steps of:
(1) placing the article within a vacuum chamber,
(2) applying a vacuum within the environment of the chamber,
(3) generating a reductive plasma within the vacuum environment of the chamber, and
(4) exposing the alloy surface to the reductive plasma for a time sufficient to reduce the metal oxide.

2. The method according to claim 1 wherein the reductive plasma comprises a concentration of active H₃⁺ ions.

3. The method according to claim 1 wherein the alloy surface further comprises at least one crevice having a surface comprising an metal oxide.

4. The method according to claim 1 wherein the vacuum within the environment of the chamber is sufficient to generate a meta-stable H₃⁺ plasma.

5. The method according to claim 4 wherein generating the meta-stable plasma comprises using a plasma generator.

6. The method according to claim 4 wherein the vacuum within the environment of the chamber is about 20 torr or less.

7. The method according to claim 6 wherein the step (2) further includes the step of purging the environment of the chamber with a reducing gas prior to or during the applying of a vacuum.

8. The method according to claim 6 wherein the vacuum is about 10 to about 15 torr.

9. The method according to claim 4 wherein the step (4) comprises directing the meta-stable plasma toward the metal oxide.

10. The method according to claim 9 wherein the directing step comprises using a plasma torch, and positioning a discharged stream of the meta-stable plasma from the plasma torch toward the metal oxide.

11. The method according to claim 10 wherein the plasma torch comprises a discharge nozzle, an electrode in non-contacting relation with the discharge nozzle, a source of a plasma-forming gas for passing through the discharge nozzle, and a power supply device for the formation of a non-transferred arc between the discharge nozzle and the electrode.

12. The method according to claim 1 wherein a reductive plasma comprising a meta-stable H₃⁺ plasma is generated from a plasma-forming gas comprising about 8% or less hydrogen gas, and a remainder of an inert gas.

13. The method according to claim 9 wherein the directing step comprises applying a reverse-bias voltage potential between the plasma generator and the alloy surface.

14. The method according to claim 12 wherein the directing step comprises passing the meta-stable plasma through a magnetically-generated channel.

15. A method of removing a metal oxide from an alloy surface of an article, comprising the steps of:
(1) placing the article within a vacuum chamber,
(2) applying a vacuum of about 20 torr or less within the environment of the chamber,
(3) using a plasma torch to generate a concentration of active H₃⁺ ion within the vacuum environment of the chamber, the plasma torch comprising a discharge nozzle, an electrode in non-contacting relation with the discharge nozzle, a source of a plasma-forming gas for passing through the discharge nozzle, and a power supply device for the formation of a non-transferred arc between the discharge nozzle and the electrode, and
(4) positioning the discharge nozzle toward the article, to direct the concentration of active H₃⁺ ion toward the metal oxide on the alloy surface for a time sufficient to reduce the metal oxide.

16. The method according to claim 15 further comprising the step of applying a reverse-bias voltage potential between the plasma torch and the alloy surface.

17. An apparatus of removing metal oxide from an alloy surface of an article, comprising:
(1) a vacuum chamber,
(2) an active H₃⁺ ion plasma generator, and
(3) a means for directing a generated H₃⁺ ion plasma to the article.

18. The apparatus according to claim 17 wherein the plasma generator comprises a H₃⁺ ion plasma discharge point positioned within the chamber.

19. The apparatus according to claim 17 wherein the plasma generator comprises a plasma torch comprising a discharge nozzle, an electrode in non-contacting relation with the discharge nozzle, a source of a plasma-forming gas for passing through the discharge nozzle, and a power supply device for the formation of a non-transferred arc between the discharge nozzle and the electrode.

20. The apparatus according to claim 19 wherein the plasma-forming gas comprises about 8% or less hydrogen gas, and a remainder of an inert gas.
